(19) United States
(12) Patent Application Publication
(10) Pub. No.: US 2023/0214270 A1
(43) Pub. Date: Jul. 6, 2023

(54) READINESS STATES FOR PARTITIONED INTERNAL RESOURCES OF A MEMORY CONTROLLER

(71) Applicant: Western Digital Technologies, Inc., San Jose, CA (US)

(72) Inventors: AMIR SEGEV, Meitar (IL); SHAY BENISTY, Beer Sheva (IL); ROY KROTMAN, Rishon LeZion (IL)

(73) Assignee: Western Digital Technologies, Inc., San Jose, CA (US)

(21) Appl. No.: 17/567,098

(22) Filed: Dec. 31, 2021

(51) Int. Cl. G06F 9/50; G06F 3/06

(52) U.S. Cl. CPC G06F 9/505; G06F 9/5044; G06F 9/5016; G06F 9/5094; G06F 3/0625; G06F 3/0635; G06F 3/0644; G06F 3/067

(57) ABSTRACT

Apparatus, systems, and methods are presented for controlling readiness states for partitioned internal resources of a memory controller. The controller may include at least one internal hardware resource that is partitioned so that readiness states for individual partitions of the internal hardware resource are individually controllable. The controller may determine a value for a parameter that corresponds to upcoming workload for the controller. The controller may compare the value to a set of thresholds. The controller may control the readiness states for the partitions of the internal hardware resource based on the comparison of the parameter to the set of thresholds.

### TECHNICAL FIELD

The present disclosure, in various embodiments, relates to data storage and memory, and more particularly relates to readiness states for partitioned internal resources of a memory controller.

### BACKGROUND

Various types of memory are used in mobile devices such as smartphones. For battery efficiency, smartphones and other devices may provide low-power or standby modes. To provide high performance, the power-consuming resources of a memory controller are kept ready. A memory controller that buffers data to be written in blocks may use power for buffering data in SRAM or DRAM buffers. Similarly, if a memory controller encodes data using an error correcting code, internal processing units may use power for encoding and decoding. Thus, if a low-power mode slows down the memory controller or places it in standby, performance may drop.

### SUMMARY

Apparatuses are presented for controlling readiness states for partitioned internal resources of a memory controller. In some embodiments, an apparatus includes a memory and a controller coupled to the memory. In some embodiments, the controller may include at least one internal hardware resource that is partitioned so that readiness states for individual partitions of the internal hardware resource are individually controllable. In some embodiments, the controller is configured to determine a value for a parameter that corresponds to upcoming workload for the controller. In some embodiments, the controller is configured to compare the parameter value to a set of thresholds. In some embodiments, the controller is configured to control the readiness states for the partitions of the at least one internal hardware resource based on the comparison of the parameter value to the set of thresholds.

Methods are presented for controlling power-saving states for partitioned internal resources of a memory controller. In some embodiments, a method includes receiving and queueing commands for a memory in a command queue of a controller for the memory. In further embodiments, the controller may include an internal memory that is partitioned so that power-saving states for individual partitions of the internal memory are individually controllable. In some embodiments, a method includes determining a queue depth for the command queue. In some embodiments, a method includes controlling power-saving states for partitions of the internal memory based on the queue depth.

An apparatus, in another embodiment, includes means for iteratively determining a value for a parameter that corresponds to upcoming workload for a memory controller. In further embodiments, the memory controller may include at least one internal hardware resource that is partitioned such that readiness states for individual partitions of the internal hardware resource are individually controllable. In some embodiments, an apparatus may include means for changing the readiness states for the partitions of the at least one internal hardware resource based on changes to the value of the parameter.

### BRIEF DESCRIPTION OF THE DRAWINGS

A more particular description is included below with reference to specific embodiments illustrated in the appended drawings. Understanding that these drawings depict only certain embodiments of the disclosure and are not therefore to be considered to be limiting of its scope, the disclosure is described and explained with additional specificity and detail through the use of the accompanying drawings, in which:

FIG. 1 is a schematic block diagram illustrating one embodiment of a system comprising readiness components;

FIG. 2 is a schematic block diagram illustrating one embodiment of memory element comprising a readiness component;

FIG. 3 is a schematic block diagram illustrating internal resources of a memory controller, in one embodiment;

FIG. 4 is a schematic block diagram illustrating partitioned internal memory of a memory controller, in one embodiment;

FIG. 5 is a schematic diagram illustrating components for a readiness component to control readiness states of an internal memory partition, in one embodiment;

FIG. 6 is a schematic block diagram illustrating one embodiment of a readiness component;

FIG. 7 is a schematic block diagram illustrating one embodiment of a set of thresholds;

FIG. 8 is a schematic block diagram illustrating another embodiment of a set of thresholds; and

FIG. 9 is a flow chart illustrating one embodiment of a method for controlling power-saving states for partitioned internal memory of a memory controller.

### DETAILED DESCRIPTION

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “circuit,” “module,” “apparatus,” or “system.” Furthermore, aspects of the present disclosure may take the form of a computer program product embodied in one or more non-transitory computer readable storage media storing computer readable and/or executable program code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented at least partially in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may include a single instruction, or many instructions, and may even be distributed over several different code segments, among different programs, across several memory devices, or the like. Where a module or portions of a module are implemented in software, the software portions may be stored on one or more computer readable and/or executable storage media. Any combination of one or more computer readable storage media may be utilized. A computer readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may alternatively be embodied by or implemented as a component.

A circuit, or circuitry, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

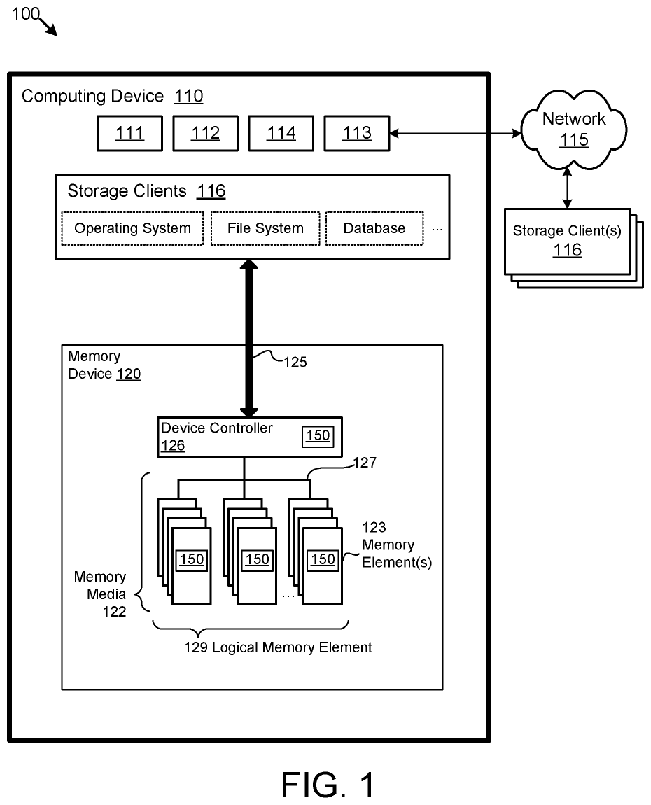

FIG. 1 is a block diagram of one embodiment of a system 100 comprising readiness components 150 for a memory device 120. The readiness components 150 may be part of memory elements 123, a device controller 126 external to the memory elements 123, and/or a device driver for the memory device 120. The readiness components 150 may communicate with or operate on a memory device 120 for or within a computing device 110, which may comprise a processor 111, volatile memory 112, a computer readable storage medium 114 and a communication interface 113. The processor 111 may comprise one or more central processing units, one or more general-purpose processors, one or more application-specific processors, one or more virtual processors (e.g., the computing device 110 may be a virtual machine operating within a host), one or more processor cores, or the like. The communication interface 113 may comprise one or more network interfaces configured to communicatively couple the computing device 110 and/or memory device 120 to a communication network 115, such as an Internet Protocol network, a Storage Area Network, or the like.

The memory device 120, in various embodiments, may be disposed in one or more different locations relative to the computing device 110. In one embodiment, the memory device 120 comprises one or more volatile and/or non-volatile memory elements 123, such as semiconductor chips or packages or other integrated circuit devices disposed on one or more printed circuit boards, storage housings, and/or other mechanical and/or electrical support structures. For example, the memory device 120 may comprise one or more direct inline memory module (DIMM) cards, one or more expansion cards and/or daughter cards, a solid-state-drive (SSD) or other hard drive device, and/or may have another memory and/or storage form factor. The memory device 120 may be integrated with and/or mounted on a motherboard of the computing device 110, installed in a port and/or slot of the computing device 110, installed on a different computing device 110 and/or a dedicated storage appliance on the network 115, in communication with the computing device 110 over an external bus (e.g., an external hard drive), or the like.

The memory device 120, in one embodiment, may be disposed on a bus 125 of the computing device 110 to communicate with storage clients 116. In one embodiment, the memory device 120 may be disposed on a memory bus of a processor 111 (e.g., on the same memory bus as the volatile memory 112, on a different memory bus from the volatile memory 112, in place of the volatile memory 112, or the like). In a further embodiment, the memory device 120 may be disposed on a peripheral bus of the computing device 110, such as a peripheral component interconnect express (PCI Express or PCIe) bus, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the memory device 120 may be disposed on a data network 115, such as an Ethernet network, an Infiniband network, SCSI RDMA over a network 115, a storage area network (SAN), a local area network (LAN), a wide area network (WAN) such as the Internet, another wired and/or wireless network 115, or the like.

In one embodiment, the memory device 120 is configured to receive storage requests from a device driver or other executable application via a bus 125. The memory device 120 may be further configured to transfer data to/from a device driver and/or storage clients 116 via the bus 125. Accordingly, the memory device 120, in some embodiments, may comprise and/or be in communication with one or more direct memory access (DMA) modules, remote DMA modules, bus controllers, bridges, buffers, and so on to facilitate the transfer of storage requests and associated data. In another embodiment, the memory device 120 may receive storage requests as an API call from a storage client 116, as an IO-CTL command, or the like.

According to various embodiments, a device controller 126 may manage one or more memory devices 120 and/or memory elements 123. The memory device(s) 120 may comprise recording, memory, and/or storage devices, such as solid-state storage device(s) and/or semiconductor storage device(s) that are arranged and/or partitioned into a plurality of addressable media storage locations. As used herein, a media storage location refers to any physical unit of memory (e.g., any quantity of physical storage media on a memory device 120). Memory units may include, but are not limited to: pages, memory divisions, blocks, sectors, collections or sets of physical storage locations (e.g., logical pages, logical blocks), or the like.

The communication interface 113 may comprise one or more network interfaces configured to communicatively couple the computing device 110 and/or the memory device 120 to a network 115 and/or to one or more remote, network-accessible storage clients 116. The storage clients 116 may include local storage clients 116 operating on the computing device 110 and/or remote, storage clients 116 accessible via the network 115 and/or the communication interface 113. A device controller 126 may be part of and/or in communication with one or more memory devices 120. Although FIG. 1 depicts a single memory device 120, the disclosure is not limited in this regard and could be adapted to incorporate any number of memory devices 120.

The memory device 120 may comprise one or more elements 123 of volatile and/or non-volatile memory media 122, which may include but is not limited to: volatile memory such as SRAM and/or DRAM; non-volatile memory such as ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), and/or optical storage media; or other memory and/or storage media. The one or more elements 123 of memory media 122, in certain embodiments, comprise storage class memory (SCM).

While the memory media 122 is referred to herein as “memory media,” in various embodiments, the memory media 122 may more generally comprise one or more volatile and/or non-volatile recording media capable of recording data, which may be referred to as a memory medium, a storage medium, or the like. Further, the memory device 120, in various embodiments, may comprise a recording device, a memory device, a storage device, or the like. Similarly, a memory element 123, in various embodiments, may comprise a recording element, a memory element, a storage element, or the like.

The memory media 122 may comprise one or more memory elements 123, which may include, but are not limited to: chips, packages, planes, die, or the like. A device controller 126, external to the one or more memory elements 123, may be configured to manage data operations on the memory media 122, and may comprise one or more processors, programmable processors (e.g., FPGAs), ASICs, micro-controllers, or the like. In some embodiments, the device controller 126 is configured to store data on and/or read data from the memory media 122, to transfer data to/from the memory device 120, and so on.

The device controller 126 may be communicatively coupled to the memory media 122 by way of a bus 127. The bus 127 may comprise an I/O bus for communicating data to/from the memory elements 123. The bus 127 may further comprise a control bus for communicating addressing and other command and control information to the memory elements 123. In some embodiments, the bus 127 may communicatively couple the memory elements 123 to the device controller 126 in parallel. This parallel access may allow the memory elements 123 to be managed as a group, forming a logical memory element 129. The logical memory element may be partitioned into respective logical memory units (e.g., logical pages) and/or logical memory divisions (e.g., logical blocks). The logical memory units may be formed by logically combining physical memory units of each of the memory elements 123.

The device controller 126 may comprise and/or be in communication with a device driver executing on the computing device 110. A device driver may provide storage services to the storage clients 116 via one or more interfaces. For example, a device driver may include a memory device interface that is configured to transfer data, commands, and/or queries to the device controller 126 over a bus 125, as described above. In some embodiments, a device driver may include executable code stored by a non-transitory computer readable medium (e.g., volatile memory 112, or computer readable storage medium 114), and/or a processor executing the code (e.g., processor 111).

In various types of memory elements 123 and/or memory devices 120, a controller (such as device controller 126 or an internal controller for a memory element 123) may include internal resources such as internal memory for buffering data, to be written to or read from the memory, and central processing units to control the read and write processes, encode and decode data with error-correcting codes, or the like. Power draw to operate processors, internal memory, or other internal resources may be high.

Thus, in computing devices that are battery powered (such as smartphone or tablets), the power draw from the memory controller may affect battery life. To provide high performance, the power-consuming resources of a memory controller may be kept ready. Such a device may provide a low-power or standby mode, but slowing or powering down the memory controller may require additional time before any application is able to use the memory. The high power utilization of internal controller resources presents a tradeoff between battery life and memory performance.

Accordingly, in various embodiments, memory elements 123 and/or a device controller 126 may include readiness components 150. At least one internal hardware resource of a memory controller may be partitioned so that readiness states for individual partitions of the internal hardware resource are individually controllable. In some embodiments, a readiness component 150 is configured to determine a value for a parameter that corresponds to upcoming workload for the controller. In some embodiments, the readiness component 150 is configured to compare the parameter value to a set of thresholds. In some embodiments, the readiness component 150 is configured to control the readiness states for the partitions of the at least one internal hardware resource based on the comparison of the parameter to the set of thresholds.

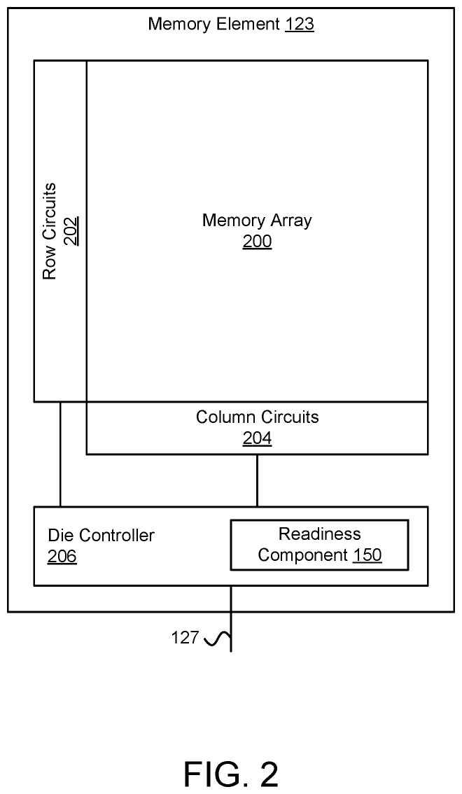

With internal resources of the controller partitioned into separately controllable partitions, the readiness of some partitions may be reduced while keeping other partitions fully ready. For example, if internal memory is divided into partitions or processors are partitioned into individual processing units or groups, one partition may be fully ready or actually in use, while another partition is in a reduced power standby state and another partition is turned off, using no power. Thus, partitioning resources to control the partitions based on needs or upcoming workload may provide low power use while still providing high performance. Readiness components 150, partitions of internal memory, and readiness states for the partitions are described in further detail below with reference to FIGS. 2-9.

FIG. 2 depicts one embodiment of a memory element 123. The memory element 123 may be substantially similar to the memory element 123 described above with reference to FIG. 1, and may be a chip, a die, a die plane, or the like. In the depicted embodiment, the memory element 123 includes a memory array 200, row circuits 202, column circuits 204, and a die controller 206.

In various embodiments, a memory element 123 may be an integrated circuit that includes both a core array 200 of memory cells (e.g., volatile and/or non-volatile memory cells) for data storage, and peripheral components (e.g., row circuits 202, column circuits 204, and/or die controller 206) for communicating with the array 200. In certain embodiments, one or more memory elements 123 may be included in a memory device 120.

In the depicted embodiment, the array 200 includes a plurality of memory cells. In one embodiment, the array 200 may be a two-dimensional array. In another embodiment, the array 200 may be a three-dimensional array that includes multiple planes and/or layers of memory cells. In various embodiments, the array 200 may be addressable by rows via row circuits 202, and by columns via column circuits 204. In various embodiments, a “cell” may refer to a smallest or fundamental physical unit of memory, or storage, for an array 200, and may be referred to interchangeably as a “storage cell,” a “memory cell” or the like. For example, a cell may be a floating gate transistor for NAND flash memory, a memristor for resistive memory, or the like. Thus, in a further embodiment, an array 200 of cells may be a two-dimensional grid, a three-dimensional block, a group, or other similar set of cells where data can be physically stored, for short- term memory use, long-term storage use, or the like.

The die controller 206, in certain embodiments, cooperates with the row circuits 202 and the column circuits 204 to perform memory operations on the array 200. In various embodiments, the die controller 206 may include components such as a power control circuit that controls the power and voltages supplied to the row circuits 202 and column circuits 204 during memory operations, an address decoder that translates a received address to a hardware address used by the row circuits 202 and column circuits 204, a state machine that implements and controls the memory operations, and the like. The die controller 206 may communicate with a computing device 110, a processor 115, a bus controller, a storage device controller, a memory module controller, or the like, via bus 127, to receive command and address information, transfer data, or the like. In one embodiment, the die controller 206 may include a readiness component 150, which may be substantially similar to the readiness component 150 described above with reference to FIG. 1.

In the following description, a readiness component 150 is described in relation to a “controller” for a “memory.” The memory may be volatile or non-volatile memory and may include a single die or memory element 123, and/or multiple memory elements 123. Similarly, the controller may be an on-die controller such as the die controller 206 of FIG. 2, or may communicate with one or more dies or memory elements 123 (as depicted for device controller 126 in FIG. 1).

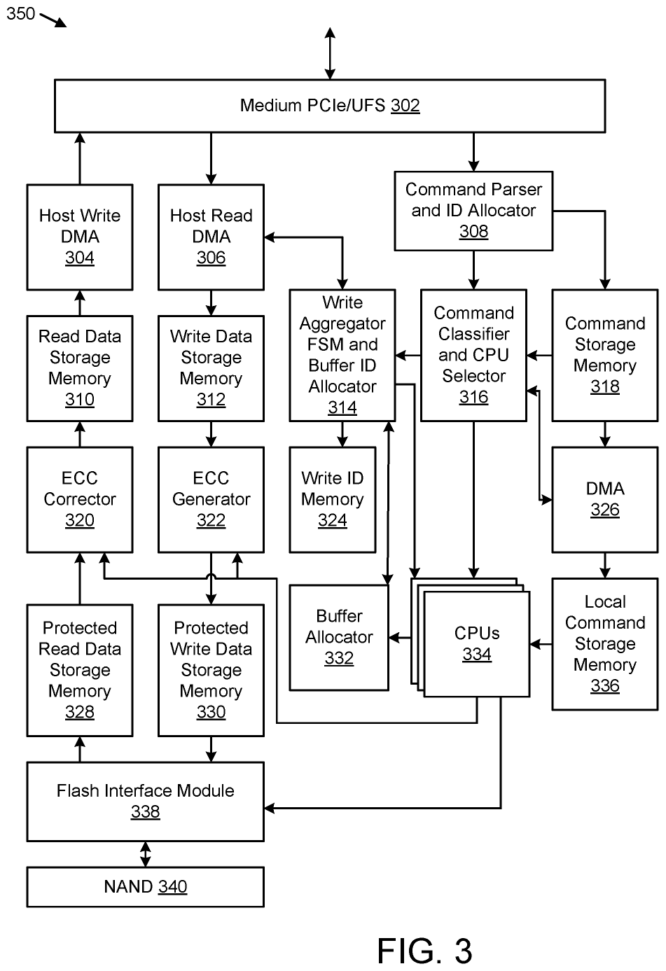

FIG. 3 depicts internal resources 350 of a memory controller, in one embodiment. The internal resources 350 may include or communicate with a readiness component 150 (not shown in FIG. 3). Use of the internal resources to write data from a host (such as the computing device 116) to memory, and to read data from the memory for the host, is described below to illustrate how various internal components are used, and to provide a greater understanding of which internal components may be partitioned to have separately controlled readiness states. Although various internal resources are depicted, some internal resources of a controller may not be depicted in FIG. 3, for clarity in describing the depicted resources. Also, in some embodiments, a controller may include, more, fewer, and/or different resources than are depicted in FIG. 3.

In the depicted embodiment, the memory is NAND Flash memory 340 that the controller uses a Flash interface module 338 to directly interface with. The controller coupled to a memory may control read and write operations for the memory, which transfer data between the memory and the host. In the depicted embodiment, the controller communicates with the host via a medium 302 such as a PCIe bus, a medium supporting a Universal Flash Storage (UFS) specification, or the like. In various other or further embodiments, a controller may control a type of memory other than NAND Flash 340, and/or may communicate with a host over another type of medium 302.

In one embodiment, for a write command, the command arrives through the PCIe medium 302 to the command parser and ID allocator 308, which parses the command and allocates a command identifier. Command and parsing results are stored in command storage memory 318 at a location based on the allocated command identifier. The command identifier is passed to a command classifier and central processing unit (CPU) selector 316, which reads the command from command storage memory 318, and passes the command to the write aggregator finite state machine (FSM) and buffer ID allocator 314, which selects a write-buffer identifier. The write aggregator FSM 314 requests buffers for data and a location for the write-buffer identifier from the buffer allocator 332.

The write aggregator FSM 314 prepares a linked list data structure in the write identifier memory 324 (e.g., a list of commands, selected buffer identifiers, and/or allocated buffer locations). The write aggregator FSM 314 instructs the host read DMA 306 to read the data from the host. The host read DMA 306 reads data from the host through the PCIe medium 302, and writes it in write data memory 312, at a location based upon the buffer allocator, as it appears in the linked list. The read DMA 306 informs the write aggregator FSM 314 that data transfer has completed.

When enough data has been buffered to write the data to memory (e.g., a NAND page size), the write aggregator FSM 314 alerts one of the CPUs 334. The CPU calculates where in memory (NAND 340) the data should be written, and alerts the error-correcting code (ECC) generator 322 and the Flash interface module 338

The ECC generator 322 reads the linked list from write identifier memory 324 to find the address of the data in the write data storage memory 312, generates the ECC protection information (e.g., encodes the data), and passes the data to the protected write data storage memory 330. The Flash interface module 338 reads the data from the protected write data storage memory 330, writes it to the NAND 340, and releases the related resources, such as a CPU thread for the CPUs 334, information stored in the command storage memory 318 based on the command identifier, write data buffers in the write data storage memory 312, linked list entries in the write identifier memory 324, and the like.

In one embodiment, for a read command, the command arrives through the PCIe medium 302 to the command parser and ID allocator 308, which parses the command and allocates a command identifier. Command and parsing results are stored in command storage memory 318 at a location based on the allocated command identifier. The command identifier is passed to a command classifier and CPU selector 316, which reads the command from command storage memory 318. The command classifier and CPU selector 316 selects one of the CPUs 334 and instructs the DMA 326 to pass the command based on the command identifier. The DMA 326 then copies the read command from the command storage memory 318 to the local command storage memory 336, which is more easily accessed by the selected CPU 334. The DMA 326 informs the command classifier and CPU selector 316 that the command has been passed.

The command classifier and CPU selector 316 informs the selected CPU 334 that it has a valid read command in its local command storage memory 336, and the CPU 334 asks for resources from the buffer allocator 332. With buffers allocated, the CPU then activates the Flash interface module 338 to read data from the NAND 340 into the protected read data storage memory 328, activates the ECC corrector 320 to correct and decode the data using an error correcting code and store the decoded data in the read data storage memory 310, and lastly activates the host write DMA 304 to pass the decoded data from the read data storage memory 310 through the medium 302 to the host. Once the command has been completed, the relevant resources are released, such as a CPU thread for the CPUs 334, information stored in the command storage memory 318 based on the command identifier, read data buffers in the read data storage memory 310, and the like.

The above description of internal components and their use for read and write commands is provided as an example. It is not intended to limit the number or type of internal resources for a memory controller or the ways in which such resources may be used.

However, in various embodiments, a controller may include internal resources such as internal memory and CPUs 334. Internal memory may include static random access memory (SRAM) and/or dynamic random access memory (DRAM), and may be used in any component that buffers commands and/or data. For example, in the depicted embodiment, components that use or include internal memory include the read data storage memory 310, write data storage memory 312, command storage memory 318, write identifier memory 324, protected read data storage memory 328, protected write data storage memory 330, and local command storage memory 336.

The extent of internal memory and processing resources (such as the amount of internal memory and the number of CPUs 334) may affect the performance and bandwidth of a memory controller. For example, a controller with more internal memory and CPUs may be able to buffer and service a larger number of commands than a controller with less internal memory or fewer CPUs. However, a controller with more internal resources, for high bandwidth, may consume more power than a controller with fewer internal resources. Thus, in various embodiment, using a readiness component 150 to control readiness states (or power-saving states) for partitions of internal components may allow a controller to provide high bandwidth with reduced power consumption as compared to a controller without a readiness component 150.

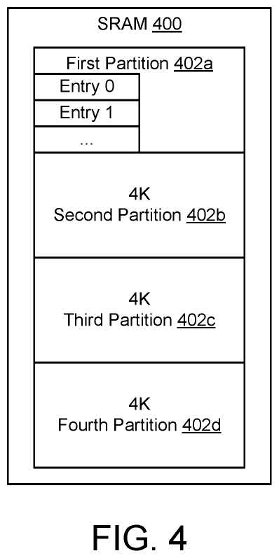

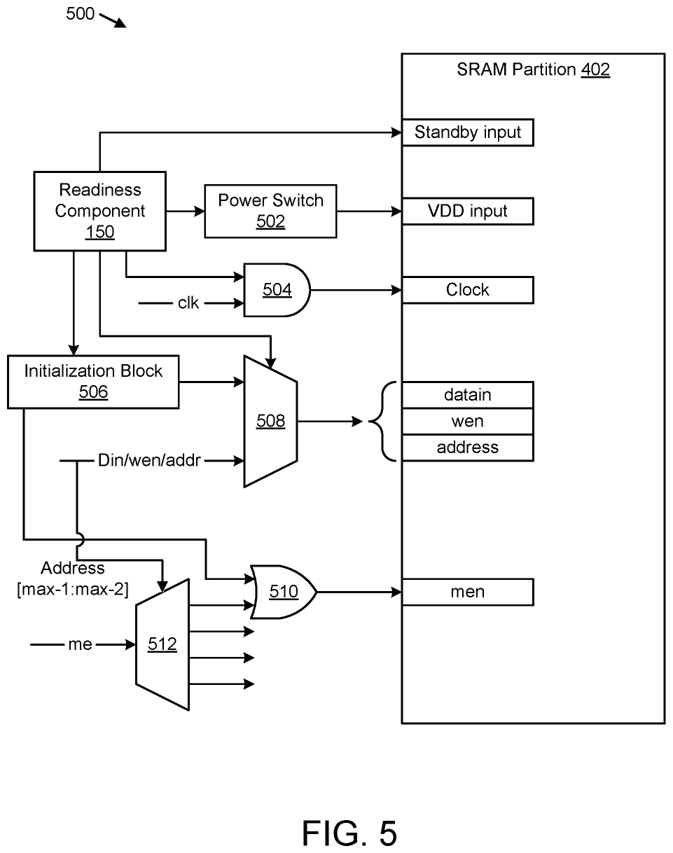

FIG. 4 depicts one example of an SRAM 400, used as internal memory for a memory controller. The 16 KiB SRAM 400 is partitioned or divided into four 4 KiB partitions 402a-d, so that readiness states for individual partitions 402a-d are individually controllable. Partitioning a resource so that individual partitions 402a-d are individually controllable may include providing separate hardware (e.g., separate dies, chips, or the like) in the controller for the separate partitions so that each partition can be powered up or down, placed on standby, or the like, as described below with reference to FIG. 5. For example, in the depicted embodiment, each partition 402a-d may be an SRAM chip or die. Although FIG. 4 depicts four equal size partitions 402a-d, various embodiments of partitioned internal resources for a memory controller may include more or fewer than four partitions, partitions of unequal size, or the like

In the depicted embodiment, memory addresses in the SRAM 400 increase starting from the first partition 402a, into the second, third, and fourth partitions 402b-d in order. The SRAM is in use, with entries (e.g., buffered data for read or write operations) in the first partition. The controller may write to the SRAM 400 in lowest available address order (e.g., a first free index order), meaning that the next entry to be written to the SRAM 400 will be written to the lowest address that is available. Thus, the addresses in in the first partition 402a will be used before addresses in the second partition 402b, which in turn will be used before addresses in the third partition 402c and so on. Accordingly, the second partition 402b may not need to be ready for use until the first partition 402a is full, or nearly full. Until that time, the second partition 402b and may be maintained in a state of lower readiness, that uses less power. Similarly, while the second partition is in a state of lower readiness, the third partition 402c may be further away from being needed or used, and may be maintained in a state of even lower readiness that uses even less power, until the second partition 402b is at least used, or is close to full.

More generally, partitioning internal resources of a memory controller and using the partitions in a predictable order, such as a lowest address first order, a lowest processor number order, or the like, may make it easier to predict when individual partitions may be needed or used. Thus, the partitions that are not likely to be used in the near future may be maintained in a state of lower readiness or greater power saving.

In some embodiments, however, development or debugging may be facilitated by using memory in another order. The controller may write to the SRAM 400 in least recently used address order, meaning that the next entry to be written to the SRAM 400 will be written to the address that has been used least recently. This order may avoid overwriting data in recently-deallocated addresses, allowing the de-allocated resource to be examined for debugging if a bug is encountered. However, least recently used address order may also provide less predictability as to which partitions 402a-d will be used at what times. Thus, in some embodiments, a controller may provide multiple modes, where it writes to the internal memory in lowest available address order (e.g., a first free index order) in a first mode (for normal operations), and writes to the internal memory in least recently used address order in in a second mode (for development or debugging).

FIG. 5 is a schematic diagram illustrating components 500 for a readiness component to control readiness states of an internal memory partition 402, in one embodiment. The memory partition 402 may be a partition of an internal memory, as described above with reference to partitions 402a-d of SRAM 400 in FIG. 4.

A readiness state, or a power-saving state, for a partition of a memory controller's internal hardware resources may include any state that affects the readiness of the partition 402 to be used, and/or the amount of power consumed by the partition 402. Often, states that save more power are associated with lower readiness, and states that provide higher readiness use more power. For example, in the depicted embodiment, the SRAM partition 402 includes a power (VDD) input, a standby pin, and a clock inpu.t. Turning off the power to the VDD input provides high power savings, but involves a longer time to return the partition 402 to an active or fully ready state. For example, after power on, the partition 402 may be initialized by writing zeros to the memory addresses in the partition to clear unknown states and avoid error correction issues.

Asserting the standby pin places the partition in a standby mode, with medium power savings, and a medium amount of time to return to an active or fully ready state once the standby pin is de-asserted. Using an AND gate 504 to turn off the clock signal to the clock pin provides low power savings, but a fast return to active once the clock is restored. These examples of readiness states are provided as illustrations, and are not intended as limiting. In various other or further embodiments, a partition of an internal hardware resource for a memory controller may have more or fewer readiness states or may have readiness states that are controlled other than via power, standby and clock inputs.

In FIG. 5, the components 500 used to control readiness states for one partition 402 are depicted. In the depicted embodiment, some components such as the power switch 502, the AND gate 504, the multiplexer 508, and the OR gate 510 may be repeated per-partition. For example, a controller with four memory partitions 402 may include four AND gates 504 to control clock signals to the partitions. Some components, however, such as the readiness component 150, the initialization block 506, and the demultiplexer 512 may be provided once and coupled to the multiple partitions.

In some embodiments, the readiness component 150 may be, or may include a finite state machine that controls a finite number of possible states for the partitions. A finite state machine may perform predetermined steps to transition between states, based on predetermined conditions.

In some embodiments, the readiness component 150 may control readiness states for a partition 402 by controlling a power state for the partition 402. Controlling a power state may include turning the power off to the partition 402, or turning on and initializing the partition 402. To take the partition 402 into the lowest-power (“off”) state (e.g., from a medium-power standby state), the readiness component 150 operates the power switch 502 to turn power to the VDD input off. To take the partition 402 back into a higher-power state (e.g., the standby state), the readiness component 150 operates the power switch to turn the power back on. The readiness component 150 may perform or initiate initialization steps, such as deasserting the standby input, enabling the clock input, activating the initialization block 506 to write zeros to the addresses in the partition, and controlling the multiplexer 508 so that the data, write enable, and address ports of the partition 402 receive signals from the initialization block 506 rather than from the data, write enable, and address lines that are used for reading or writing (non-initialization) data. Once initialization is complete, the readiness component 150 may assert the standby pin, disable the clock input, disable the initialization block 506, and control the multiplexer 508 so that the data, write enable, and address ports of the partition 402 are coupled to the data, write enable, and address lines that are used for reading or writing (non-initialization) data, rather than to the initialization block 506. With these steps completed, the partition is no longer in the “off” state but is in a medium-power standby state.

In some embodiments, the readiness component 150 may control readiness states for a partition 402 by controlling a standby state for the partition 402. Controlling a standby state may include asserting or de-asserting a standby pin for the partition 402, or sending various other or further types of signals to various other or further types of inputs for a partition 402 to enter or leave a standby state, depending on what inputs the partition 402 provides. In the depicted embodiment, to take the partition 402 into the medium-power standby state (e.g., from a higher-power clock gated state), the readiness component 150 asserts the standby pin for the partition 402. To take the partition back into a higher-power, higher-readiness state, the readiness component deasserts the standby pin for the partition 402. Use of a standby pin rather than the power switch 502 provides a faster return to full readiness because the initialization described above for powering on the partition 402 is not repeated for deasserting the standby pin.

In some embodiments, the readiness component 150 may control readiness states for a partition 402 by gating a clock signal for the partition 402. Gating a clock signal, in various embodiments, may include using any logic gates or other logic components to control whether the partition 402 receives or does not receive the clock signal. In the depicted embodiment, the AND gate 504 has one input coupled to the clock signal, with its output coupled to the clock pin for the partition 402. The other input of the AND gate 504 is coupled to the readiness component 150. To take the partition 402 into a clock-gated (low power savings, high readiness) state from a higher power active or fully ready state, the readiness component 150 sets one input of the AND gate 504 low (to binary “0”), so that the AND gate 504 blocks the clock signal from the clock input. Conversely, to take the partition 402 into a fully ready state from the clock-gated state, the readiness component 150 merely sets one input of the AND gate high (to binary “1”), so that the AND gate 504 couples the clock signal to the clock input. Various other types of logic gate may be used to gate a clock signal based on a high or low input, in various other or further embodiments. The clock-gated state in which the clock is turned off (for the partition 402) provides a small amount of power reduction, but a rapid return to full readiness compared to the standby state. (However, the clock may also be gated when in the standby state).

In the depicted embodiment, the partition 402 includes a memory enable input that is asserted to read or write data. A demultiplexer 512 splits the incoming memory enable line out to the different partitions. With four partitions, the demultiplexer 512 can be controlled to select a partition 402 based on two bits of the address. With more or fewer than four partitions, a demultiplexer 512 may provide more or fewer outputs, and may be controlled by more or fewer bits of the address. An OR gate 510 allows the memory enable input to be asserted via the incoming memory enable line, via the demultiplexer 512, or to be asserted by the initialization block 506 during the initialization process described above.

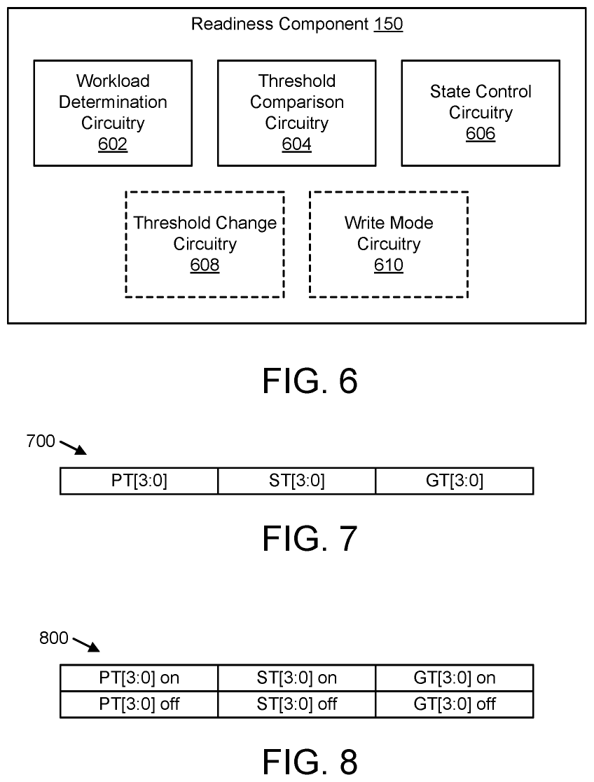

FIG. 6 depicts one embodiment of a readiness component 150, which may be substantially as described above with reference to FIGS. 1-5. In the depicted embodiment, the readiness component includes workload determination circuitry 602, threshold comparison circuitry 604, state control circuitry 606, threshold change circuitry 608, and write mode circuitry 610. Some components included in the depicted embodiment may be omitted in another embodiment, as indicated by dashed lines. For example, in some embodiments, the threshold change circuitry 608 and/or the write mode circuitry 610 may be omitted. In various other or further embodiments, a readiness component 150 may include or omit various other or further components.

The readiness component 150, as described above may be implemented in or by a controller coupled to a memory. The controller may be a device controller 126 for a memory, a die controller 206 for a memory, or the like. The controller may include at least one internal hardware resource that is partitioned such that readiness states (e.g., power-saving states) for individual partitions of the internal hardware resource are individually controllable by the readiness component. An internal hardware resource may include any controller hardware that uses power, such as internal memory (SRAM or DRAM), internal processing units (CPUs or groups of CPUs), or other hardware. As described above, hardware that is partitioned to be individually controllable may include separate chips, dies, planes, or regions with separate control inputs (e.g., power, standby, and clock pins, or the like) coupled to the readiness component 150 to individually or separately control the partitions. A partition may include a range of memory addresses, a CPU, a group of CPUs, or the like. Although control of the partitions via power, standby, and clock pins is described above with reference to FIG. 5, control of a partition with other types of inputs may include controlling those inputs.

The workload determination circuitry 602, in various embodiments, is configured to determine a value for a parameter that corresponds to upcoming workload for the controller. A parameter that corresponds to upcoming workload for the controller may be any measurable quantity that is related to upcoming needs for resources. In various embodiments, such a parameter may be command queue depth, the number of resource partitions currently in use, the highest memory address currently in use, the number of CPUs in use, or the like. For example, in one embodiment, commands for a memory may be received and queued commands in a command queue of the controller (which uses internal memory for the queue), and the workload determination circuitry 602 may determining a queue depth (e.g., a number of active entries) for the command queue.

In some embodiments, the workload determination circuitry 602 may iteratively determine the value of the parameter corresponds to upcoming workload. In other words, the workload determination circuitry 602 may monitor the parameter (e.g., queue depth) over time, allowing the readiness component 150 to change readiness states for the partitions of internal resources as predicted workloads increase or decrease.

Circuitry for determining a parameter may include a register or buffer that receives the parameter (e.g., coupled to high bits of address lines to detect whether high addresses are being used), a counter to count the number of resources currently in use, arithmetic hardware to calculate the parameter based on other information, a finite state machine, or the like. Various embodiments may include other or further circuitry for determining a parameter.

The threshold comparison circuitry 604, in various embodiments, may compare the value of the parameter, as determined by the workload determination circuitry 602, to a set of thresholds. A threshold, in various embodiments, may be a number or other value, or any other condition that is used as a basis for changing readiness states of the partitions, if the condition is (or is not) satisfied. For example, if the parameter is a queue depth or a number of active allocated resources a threshold may be a queue depth or number of active partitions that suggests that another partition is likely to be needed soon (so that the readiness component 150 increases the readiness state of a partition), or that a partition at one readiness state can safely be brought into a lower-readiness (more power-saving) state. Some examples of sets of thresholds are described below with reference to FIGS. 7 and 8.

Circuitry for comparing a parameter value to a set of thresholds, in various embodiments, may include one or more registers or buffers for storing the thresholds, one or more comparators for comparing the parameter value to the thresholds, arithmetic hardware for subtracting the parameter value from the thresholds (or vice versa), a finite state machine, or the like. Various embodiments may include other or further circuitry for comparing a parameter value to a set of thresholds.

The state control circuitry 606, in various embodiments, is configured to control the readiness states for the partitions, based on the comparison of the parameter to the set of thresholds by the threshold comparison circuitry 604. As described above, a readiness state, or a power-saving state, for a partition of a memory controller's internal hardware resources may include any state that affects the readiness of the partition to be used, and/or the amount of power consumed by the partition. Thus, in various embodiments, a readiness state may be a power off state, a standby state, a clock gated state, or the like, as described above with reference to FIG. 5.

Controlling readiness states based on the comparison of the parameter value to the thresholds, in further embodiments, may include changing between states or maintaining a partition in the same state, based on which of the thresholds in the set of thresholds are or are not satisfied by the parameter value. For example, state control circuitry 606 may control power-saving states for partitions of the internal memory based on the queue depth of a command queue, to make the next unused partition more ready when the queue depth is long enough that the next partition is likely to be used soon, or to decrease the power consumption of the next partition when the queue depth is short enough that the next partition is not likely to be used soon. As a further example, where the workload determination circuitry 602 iteratively determines the value of a parameter over time, the state control circuitry 606 may change readiness states for one or more of the partitions based on changes to the value of the parameter over time, such as in response to the parameter changing to satisfy (or changing to fail to satisfy) a threshold.

Circuitry for controlling readiness states may include components such as logic gates for asserting or deasserting a standby pin, logic gates for controlling an input of a power switch 502, logic gates for controlling an input of a gate 504 for clock gating, the power switch 502 and the AND gate 504 themselves, an initialization block 506, a finite state machine, or the like, as described above with reference to FIG. 5. Various embodiments may include other or further circuitry for controlling readiness states.

As described above with reference to FIG. 5, in some embodiments, the state control circuitry 606 may control readiness or power-saving states by controlling power states (on or off) for at least one of the partitions, controlling standby states for at least one of the partitions, gating clock signals for at least one of the partitions, or the like. In some embodiments, partitions may have more or fewer readiness states than are describe herein, or different readiness states. For example, a partition of processing resources such as a CPU may have different readiness states than a partition of internal memory resources, and the states may be controlled in other ways. However, the state control circuitry 606 may control those states in the ways that are available for that type of partition. In some embodiments, the state control circuitry 606 may not utilize all the readiness states made possible by the hardware of the partitions, but may omit one or more of the possible readiness states. For example, in some embodiments, state control circuitry 606 may not implement a power off state, and the partitions may be kept on (or off) together instead of being individually switched on or off.

In some embodiments, the state control circuitry 606 may change readiness states for the partitions by one state at a time within an ordered sequence of states. For example, one such sequence may be the sequence of the power off state, the standby state, the clock gated state, and the ready state. To change states by one state at a time, the state control circuitry 606 changes a partition from its present state into an adjacent state. Thus, if a state is changed, a partition in the power off state may be changed to the standby state; a partition in the standby state may be changed to the power off state or the clock gated state; a partition in the clock gated state may be changed to the standby state or the ready state; and a partition in the ready state may be changed to the clock gated states. Changing states one at a time in an ordered sequence (e.g., only between adjacent states) may help to avoid skipping steps such as initializing a memory partition after powering it on, because a smaller number of state transitions are well defined.

The threshold change circuitry 608, in various embodiments, may change the set of thresholds over time, based on usage history for the internal hardware resource (and its partitions) that the thresholds are used to control. For example, if usage history records a high number, percentage, or other metric of instances where a partition was brought into a higher-readiness state but unused, a threshold may be changed by threshold change circuitry 608 to keep the partition in a lower-readiness state longer, to save more power. Conversely, if usage history records a high number, percentage, or other metric of instances where a partition was not already in a fully ready state by the time it was needed, the threshold change circuitry 608 may change a threshold to make the partition ready earlier. Dynamically changing power-saving thresholds over time based on usage history for partitions of an internal memory or another resource may tune the controller to have its internal resources to be ready based on how it is typically used.

Circuitry for changing the set of thresholds over time, in various embodiments, may include storage for maintaining a usage history and a set of thresholds, logic hardware for determining if the usage history justifies changing the set of thresholds, a finite state machine, or the like. Various embodiments may include other or further circuitry for changing the set of thresholds.

Write mode circuitry 610, in some embodiments, may include circuitry for switching modes for writing to an internal memory. As described above, with reference to FIG. 5, a controller may write to its internal memory in lowest available address order (e.g., a first free index order). By allocating memory from the lowest address (or other resources from a lowest index), the readiness component 150 can track how much of the memory (or other resources) is used, and increase the readiness state ahead of time for resources that are likely to be used by upcoming workloads. Similarly, the readiness component 150 can decrease the readiness state for partitions that are not likely to be used by immediately upcoming workloads. Decreasing readiness states for partitions that are not likely to be used may save power without impacting performance.

However, as described above, development or debugging may be facilitated by the controller writing to its internal memory in least recently used address order, to facilitate inspecting information in recently-deallocated addresses if something goes wrong. Thus, in some embodiments, the write mode circuitry 610 may be used to switch between a first mode where the controller writes to the internal memory in lowest available address order (e.g., a first free index order), and a second mode (e.g., debug mode), where the controller writes to the internal memory in least recently used address order.

Circuitry for switching modes may include circuitry for implementing the modes such as a bitmap of allocated addresses to determine the lowest available address, and/or a list of addresses in the order they were previously used to determine the least-recently-used address. In some embodiments, circuitry for switching modes may include or communicate with the mode implementation circuitry for both modes, and may include logic hardware for selecting which set of mode implementation circuitry is used. Various embodiments may include other or further circuitry for switching modes.

FIG. 7 depicts one embodiment of a set of thresholds 700. In some embodiments, a set of thresholds may include a plurality of different thresholds for setting different partitions to different readiness states. Setting different partitions to different readiness states allows the active or soon to be active partitions to provide high performance, while partitions that are not immediately needed provide power savings in a lower readiness state. Thus, in some embodiments, a set of thresholds includes multiple subsets of thresholds corresponding for readiness states for multiple partitions, where the thresholds for different subsets are different.

For example, in the depicted embodiment, an internal memory is partitioned into four partitions labelled 0 through 3. The set of thresholds 700 includes four thresholds PT[3:0] for controlling when partitions 0-3 are turned on or off; four thresholds ST[3:0] for controlling when to assert a standby pin for partitions 0-3, and four thresholds GT[3:0] for controlling when to gate a clock signal for partitions 0-3. The value of the thresholds may be a queue depth, a number of addresses in use, or the like so that when the queue becomes deeper or more addresses are used, more partitions are brought into higher-readiness states.

A subset of readiness state thresholds for the first partition may be one of each type of thresholds, such as PT[0], ST[0], and GT[0]. Similarly, a subset of readiness state thresholds for the second partition may be PT[1], ST[1], and GT[1], and so on.

FIG. 8 depicts one embodiment of a set of thresholds 800, including PT, ST, and GT thresholds as described above with reference to FIG. 7. However, if the parameter that is compared to the thresholds is close to one of the thresholds it may fluctuate so that a threshold is repeatedly satisfied than not satisfied. Rapidly and repeatedly changing readiness states may cause spikes of high power demand.

Accordingly, in the depicted embodiment, the set of thresholds includes a first subset of thresholds to increase readiness states (e.g., the thresholds labelled “on”) and a second subset of thresholds to decrease readiness states (e.g., the thresholds labelled “off”). The subset of thresholds to decrease readiness states may differ from the subset of thresholds to increase readiness states, thus providing some hysteresis to avoid too-rapid toggling between readiness states. The readiness component 150 may increase a power-saving state based on comparing a parameter such as a queue depth to a first threshold (e.g., one of the “on” thresholds), and may decrease the power-saving state based on comparing the queue depth or other parameter to a second threshold (e.g., one of the “off” thresholds).

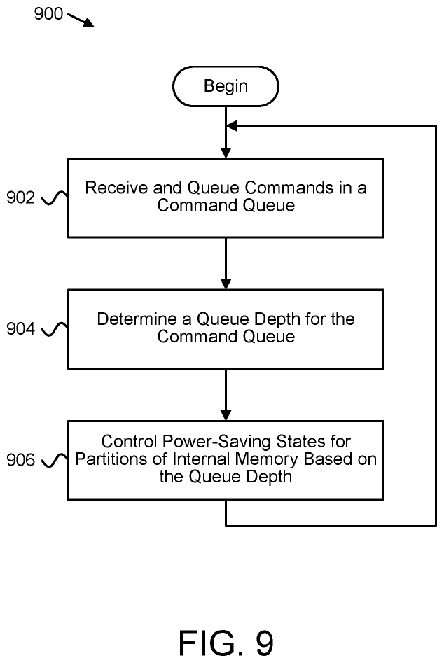

FIG. 9 is a flow chart illustrating one embodiment of a method 900 for controlling power-saving states for partitioned internal memory of a memory controller. The method 900 begins, and a controller receives and queues 902 commands for a memory in a command queue of the controller. As described above, the controller includes an internal memory that is partitioned so that power-saving states for individual partitions of the internal memory are individually controllable. The controller determines 904 a queue depth for the command queue. The controller controls 906 power-saving states for partitions of the internal memory based on the queue depth. The method 900 continues, with the controller iteratively and repeatedly queuing 902 commands, determining 904 the queue depth, and controlling 906 power-saving states based on the queue depth.

Means for iteratively determining a value for a parameter that corresponds to upcoming workload for a memory controller, in various embodiments, may include a controller, a readiness component 150, workload determination circuitry 602, and/or other logic or electronic hardware. Other embodiments may include similar or equivalent means for iteratively determining a parameter value.

Means for changing the readiness states for partitions at least one internal hardware resource based on changes to the parameter value, in various embodiments, may include a controller, a readiness component 150, threshold comparison circuitry 604, state control circuitry 606, and/or other logic or electronic hardware. Other embodiments may include similar or equivalent means for changing readiness states.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising
a memory; and
a controller coupled to the memory, the controller comprising at least one internal hardware resource that is partitioned such that readiness states for individual partitions of the internal hardware resource are individually controllable, the controller configured to:
determine a value for a parameter that corresponds to upcoming workload for the controller;
compare the parameter value to a set of thresholds; and
control the readiness states for the partitions of the at least one internal hardware resource based on the comparison of the parameter value to the set of thresholds.

2. The apparatus of claim 1, wherein the at least one internal hardware resource comprises an internal memory.

3. The apparatus of claim 1, wherein the controller controls the readiness states by controlling a power state for at least one of the partitions.

4. The apparatus of claim 1, wherein the controller controls the readiness states by controlling a standby state for at least one of the partitions.

5. The apparatus of claim 1, wherein the controller controls the readiness states by gating a clock signal for at least one of the partitions.

6. The apparatus of claim 1, wherein the set of thresholds comprises at least a first subset of thresholds corresponding to readiness states for a first partition and a second subset of thresholds corresponding to readiness states for a second partition, the second subset different from the first subset.

7. The apparatus of claim 1, wherein the controller changes readiness states for the partitions by one state at a time within an ordered sequence of states.

8. The apparatus of claim 1, wherein the set of thresholds includes a subset of thresholds to increase readiness states and a subset of thresholds to decrease readiness states that differs from the subset of thresholds to increase readiness states.

9. The apparatus of claim 1, wherein the controller is further configured to change the set of thresholds over time based on usage history for the internal hardware resource.

10. The apparatus of claim 1, wherein the at least one internal hardware resource comprises an internal memory and the controller is configured to write to the internal memory in lowest available address order.

11. The apparatus of claim 1, wherein the parameter comprises a command queue depth.

12. A method comprising:
receiving and queueing commands for a memory in a command queue of a controller for the memory, the controller comprising an internal memory that is partitioned such that power-saving states for individual partitions of the internal memory are individually controllable;
determining a queue depth for the command queue; and
controlling the power-saving states for the partitions of the internal memory based on the queue depth.

13. The method of claim 12, wherein controlling the power-saving states comprises controlling a power state for at least one of the partitions.

14. The method of claim 12, wherein controlling the power-saving states comprises controlling a standby state for at least one of the partitions.

15. The method of claim 12, wherein controlling the power-saving states comprises gating a clock signal for at least one of the partitions.

16. The method of claim 12, wherein controlling the power-saving states comprises setting different partitions to different readiness states.

17. The method of claim 12, wherein controlling the power-saving states comprises changing readiness states for the partitions by one state at a time within an ordered sequence of states.

18. The method of claim 12, wherein controlling the power-saving states comprises increasing a power-saving state based on comparing the queue depth to a first threshold and decreasing the power-saving state based on comparing the queue depth to a second threshold.

19. The method of claim 12, wherein controlling the power-saving states comprises dynamically changing power-saving thresholds over time based on usage history for the internal memory.

20. An apparatus comprising:
a memory controller including at least one internal hardware resource, wherein the internal hardware resource is partitioned such that readiness states for individual partitions of the internal hardware resource are individually controllable;
means for determining a value for a parameter that corresponds to upcoming workload for the memory controller; and
means for changing the readiness states for the partitions of the at least one internal hardware resource based on changes to the value of the parameter.
